(19) United States
(12) Patent Application Publication
(10) Pub. No.: US 2024/0371164 A1
(43) Pub. Date: Nov. 7, 2024

(54) VIDEO LOCALIZATION USING ARTIFICIAL INTELLIGENCE

(71) Applicant: Google LLC, Mountain View, CA (US)

(72) Inventors: Shen Yan, Kirkland, WA (US); Xuehan Xiong, Mountain View, CA (US); Arsha Nagrani, Cambridge, MA (US); Anurag Arnab, Paris (FR); David Alexander Ross, San Jose, CA (US); Cordelia Schmid, Saint-Ismier (FR)

(21) Appl. No.: 18/652,703

(22) Filed: May 1, 2024

Related U.S. Application Data
(60) Provisional application No. 63/464,176, filed on May 4, 2023.

(51) Int. Cl. G06V 20/40; G06V 10/774; G06V 10/80

(52) U.S. Cl. CPC G06V 20/44; G06V 10/774; G06V 10/806; G06V 20/46

(57) ABSTRACT

Methods and systems for video localization using artificial intelligence are provided herein. A set of video embeddings representing features of one or more video frames of a media it em and a set of textual embeddings corresponding to an event associated with the media item are obtained. Fused video-textual data is generated based on the set of video embeddings and the set of textual embeddings. The fused video-textual data indicates features of the video frames of the media item and textual data pertaining to the media item. The fused video-textual data is provided as an input to an artificial intelligence (AI) model trained to perform multiple video localization tasks with respect to media items of a platform. One or move outputs of the AI model are obtained. A segment of the media item that depicts the event is determined based on the one or move outputs of the AI model.

### RELATED APPLICATIONS

This non-provisional application claims priority to U.S. Provisional Patent Application No. 63/464,176 filed on May 4, 2023 and entitled “UnLoc: A Unified Framework for Video Localization Tasks,” which is incorporated by reference herein.

### TECHNICAL FIELD

Aspects and implementations of the present disclosure relate to video localization using artificial intelligence.

### BACKGROUND

A platform (e.g., a content platform) can transmit (e.g., stream) media items to client devices connected to the platform via a network. A media item can include a media item and/or an audio item, in some instances. Users can consume the transmitted media items via a graphical user interface (GUI) provided by the platform. In some instances, one or more content segments of a media item may be more interesting to a user than other content segments. Identification of segments of a media item that are interesting to a user and/or depict a particular event is referred to as video localization.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining a set of video embeddings that represents features of one or more video frames of a media item. The method further includes obtaining a set of textual embeddings corresponding to an event associated with the media item. The method further includes generating fused video-textual data based on the obtained set of video embeddings and the obtained set of textual embeddings. The fused video-textual data indicates features of the one or more video frames of the media item and textual data pertaining to the media item. The method further includes providing the fused video-textual data as an input to an artificial intelligence (AI) model trained to perform multiple video localization tasks with respect to media items of a platform. The method further includes obtaining one or more outputs of the AI model. The method further includes determining, based on the one or more outputs of the AI model, a segment of the media item that depicts the event.

In some implementations, the method further includes providing the one or more video frames as an input to an image encoder. The set of video embeddings is obtained based on one or more outputs of the image encoder. The method further includes providing textual data corresponding to the event associated with the media item as an input to a text encoder. The set of textual embeddings is obtained based on one or more outputs of the text encoder.

In some implementations, the image encoder and the text encoder are components of an additional AI model that is trained to predict a correspondence between given text data and given image data.

In some implementations, generating the fused video-textual data includes extracting, from the obtained set of video embeddings, a video embedding representing features of at least one of the one or more video frames. The method further includes performing one or more concatenation operations to concatenate the extracted video embedding with the set of textual embeddings. The method further includes updating a dataset to include the extracted video embedding concatenated with the set of textual embeddings.

In some implementations, the method further includes providing the updated dataset as an input to a transformer encoder, and obtaining, based on one or more outputs of the transformer encoder, a set of frame tokens reflecting a correspondence between a respective video embedding extracted from the set of video embeddings and the concatenated set of textual embeddings.

In some implementations, the method further includes performing one or more sampling operations with respect to the set of frame tokens to obtain, for each of the set of frame tokens, a set of sampled frame tokens. Each of the set of sampled frame tokens has a distinct resolution from the other sampled frame tokens of the plurality of frame tokens. The generated fused video-textual data includes the plurality of sampled frame tokens obtained for each of the set of frame tokens.

In some implementations, the set of sampled frame tokens obtained for a respective frame token of the set of frame tokens corresponds to a feature pyramid comprising a set of levels. The set of sampled frame tokens of a first level of the plurality of levels has a first resolution and the set of sampled frame tokens of a second level of the set of levels has a second resolution that is lower than the first resolution.

In some implementations, the set of video localization tasks include at least one of predicting a correspondence between a segment of the one or more media items and one or more events indicated by one or more textual embeddings of the given data, predicting a set of time stamps indicating the segment of the one or more media items that depicts one or more events indicated by the one or more textual embeddings of the given data, predicting an action pertaining to one or more objects depicted by a video frame of the one or more media items, or predicting a region of the video frame of the one or more media items depicting one or more actions that are of interest to one or more users of a platform.

In some implementations, the method further includes receiving, from a client device connected to a platform, a request for content pertaining to the event. The method further includes responsive to extracting the indication of the segment of the media item that depicts the event, providing the indicated segment of the media item for presentation via the client device in accordance with the received request.

In some implementations, the output of the AI model includes an indication of one or more segments of the media item and, for each of the one or more segments of the media item, a level of confidence that video frames of the respective segment of the media item depicts content corresponding to the event.

In some implementations, the output of the AI model further includes, for each of the one or more segments of the media item, an additional level of confidence that a duration of the one or more segments satisfies one or more duration criteria associated with a platform.

An aspect of the disclosure provides a system including a memory and a set of one or more processing devices coupled to the memory. The set of one or more processing devices is to perform operations including generating a set of training data for training an artificial intelligence (AI) model to perform multiple video localization tasks. Generating the training data includes obtaining a set of training video embeddings that represents features of one or more video frames of a training media item, obtaining a set of training textual embeddings corresponding to an event associated with the media item, generating a training input comprising fused video-textual data generated based on the obtained set of training video embeddings and the obtained set of training textual embeddings, and generating a target output for the training input. The fused video-textual data indicates features of the one or more video frames of the training media item and textual data pertaining to the media item. The target output indicates whether content of at least one of the one or more video frames of the training media item depicts the event associated with the media item. The operations further include providing the training data to train the machine learning model on (i) a set of training inputs comprising the training input and (ii) a set of target outputs comprising the target output.

In some implementations, the operations further include providing the one or more video frames of the training media item as an input to an image encoder. The set of training video embeddings is obtained based on one or more outputs of the image encoder. The operations further include providing textual data corresponding to the event associated with the training media item as an input to the text encoder. The set of training textual embeddings is obtained based on one or more outputs of the text encoder.

In some implementations, the image encoder and the text encoder are components of an additional AI model that is trained to predict a correspondence between given text data and given image data.

In some implementations, generating the training input comprising the fused video-textual data includes extracting, from the obtained set of training video embeddings, a video embedding representing features of at least one of the one or more video frames, performing one or more concatenation operations to concatenate the extracted video embedding with the set of training textual embeddings, and updating a dataset to include the extracted video embedding concatenated with the set of textual embeddings.

In some implementations, the operations further include providing the updated dataset as an input to a transformer encoder. The operations further include obtaining, based on one or more outputs of the transformer encoder, a set of frame tokens indicating a correspondence between a respective video embedding extracted from the set of training video embeddings and the concatenated set of textual embeddings.

In some implementations, the operations further include performing one or more sampling operations with respect to the set of frame tokens to obtain, for each of the set of frame tokens, a set of sampled frame tokens. Each of the set of sampled frame tokens has a distinct resolution from the other sampled frame tokens of the set of frame tokens. The generated fused video-textual data includes the plurality of sampled frame tokens obtained for each of the set of frame tokens.

In some implementations, the set of sampled frame tokens obtained for a respective frame token of the set of frame tokens corresponds to a feature pyramid comprising a set of levels. The set of sampled frame tokens of a first level of the set of levels has a first resolution and the set of sampled frame tokens of a second level of the set of levels has a second resolution that is lower than the first resolution.

In some implementations, the generated target output includes a relevancy score indicating a degree of relevancy of the content of the at least one of the one or more video frames to the event associated with the media item.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform and an example video localization engine, in accordance with implementations of the present disclosure.

FIG. 3 depicts a flow diagram of an example method for video localization using artificial intelligence (AI), in accordance with implementations of the present disclosure.

FIG. 4 depicts an example of performing video localization using AI, in accordance with implementations of the present disclosure.

FIG. 5 illustrates an example predictive system, in accordance with implementations of the present disclosure.

FIG. 6 depicts a flow diagram of another example method for training an AI model to perform one or more video localization tasks, in accordance with implementations of the present disclosure.

FIG. 7 is a block diagram illustrating an exemplary computer system, in accordance with implementations of the present disclosure.

### DETAILED DESCRIPTION

Aspects of the present disclosure relate to video localization using artificial intelligence. Video localization refers to the identification of segments of a media item (e.g., a video item, an audio item) that depicts a particular event and/or is associated with particular attributes. Video localization tasks can include moment retrieval tasks (e.g., identifying segments of a media item that correspond to an event or action of a natural language query), temporal action localization tasks (e.g., detecting a start time and/or an end time of a particular event or action and/or classifying the type of event or action taking place), action segmentation tasks (e.g., for each video frame or segment of a media item, identifying labels indicating an event or an action depicted by the video frame or segment), highlight detection tasks (e.g., identifying significant or interesting segments of a media item), and so forth.

In conventional systems, artificial intelligence (AI) models are trained to perform a single video localization task, and therefore conventional systems train and implement multiple AI models to perform each of moment retrieval tasks, temporal action localization tasks, action segmentation tasks, and highlight detection tasks. Training an AI model to perform a video localization task can involve providing the AI model with a large number of images (e.g., thousands, millions, etc.) that are labeled and/or annotated in accordance with the specific task or purpose for which the AI model is to be trained. Accordingly, obtaining training data for training multiple AI models to perform each different video localization task can take a significant amount of time. Further, training and using a single AI model to perform a video localization task can consume a significant amount of computing resources (e.g., processing cycles, memory space, etc.), and an even larger amount of computing resources are consumed to train multiple AI models to each perform distinct video localization tasks. Such computing resources are made unavailable to other processes of the system, which reduces an overall efficiency of the system and increases an overall latency of the system.

In addition, conventional video localization AI models are trained to identify events or actions from a fixed number event/action categories, which are typically defined to specified by the labels and/or annotations provided during the training process. Content sharing platforms can provide users with access to media items, which in some instances include user generated content. Media items of a content sharing platform can depict a wide range or variety of events or actions, which may not be reflected by the labels or annotations used for training video localization AI models in conventional systems. Accordingly, such AI models may not be able to accurately perform the above described video localization tasks to identify segments of the media items that depict a particular event or action (e.g., as requested by a user, etc.) and/or are of interest to a user.

Implementations of the present disclosure address the above and other deficiencies by providing methods and systems for video localization using artificial intelligence (AI). In some embodiments, the system can identify a media item for video localization. As described herein, video localization refers to the identification of a content segment of the media item that depicts an event corresponding to particular action and/or is associated with particular attributes. For purposes of explanation and illustration, an event associated with a media item, as determined by the system, can include content depicting particular actions (or types of actions), or content having particular attributes (e.g., as defined by a developer or operator of the system, associated with one or more users of the platform, etc.). The particular attributes of the content can include, but are not limited to, actions or objects of interest to users of a platform, a duration corresponding to (e.g., matching or approximately matching) a duration defined for short-form media items, actions or objects that pertain to a title or caption for the media item, and so forth. In one illustrative example, a user of a platform can provide a request for content (e.g., of a particular media item or of any media item associated with the platform) associated with “combining ingredients of a cookie recipe.” The event depicted by a segment of the media item content, as identified by the system in accordance with embodiments described below, can include the particular action of the user request (e.g., combining ingredients of a cookie recipe). In another illustrative example, upon receiving a media item from a user for sharing with other users, the system may identify a segment of content including an event that is of interest to the other users of the platform. For instance, if the media item includes a music video for a song, the system may identify the segment of content associated with a chorus of the song as content of interest. In another instance, if the media item includes a video of a soccer match where a goal is scored, the system may identify the segment of content depicting the goal as content of interest, as described herein.

As described above, the system can identify the media item upon receiving a request for content (e.g., from a user of a platform) depicting a particular event, in some embodiments. In other or similar embodiments, the system can identify the media item upon or after receiving the media item (e.g., from a user for a platform for sharing with other users of the platform). Upon identifying the media item, the system can obtain a set of video embeddings that represents features of one or more video frames of the media item and a set of textual embeddings corresponding to an event associated with the media item. In some embodiments, the system can obtain the set of video embeddings by providing the media item (or one or more video frames of the media item) as an input to an image encoder (e.g., an AI model or engine that converts an image into a vector representation that captures the visual features of the input image) and obtaining the set of video embeddings based on one or more outputs of the image encoder. In additional or alternative embodiments, the system can obtain the set of textual embeddings providing textual data corresponding to the event associated with the media item as input to a text encoder (e.g., an AI model or engine that converts text into a vector representation that captures the semantic properties of the input text) and obtaining the set of textual embeddings based on one or more outputs of the text encoder. In some embodiments, the textual data provided as input to the text encoder can include data, or metadata, associated with the media item that is provided by a user (e.g., a creator) associated with the media item, such as a title of the media item, a description or caption associated with the media item, a tag or label associated with the media item, and so forth. In additional or alternative embodiments, the textual data can include or indicate an event or action indicated by the request for content (e.g., by the user of the platform). In some embodiments, the image encoder and the text encoder can be components of an AI model that is trained to learn visual concepts from natural language supervision (e.g., trained to predict a correspondence between given text data and given image data).

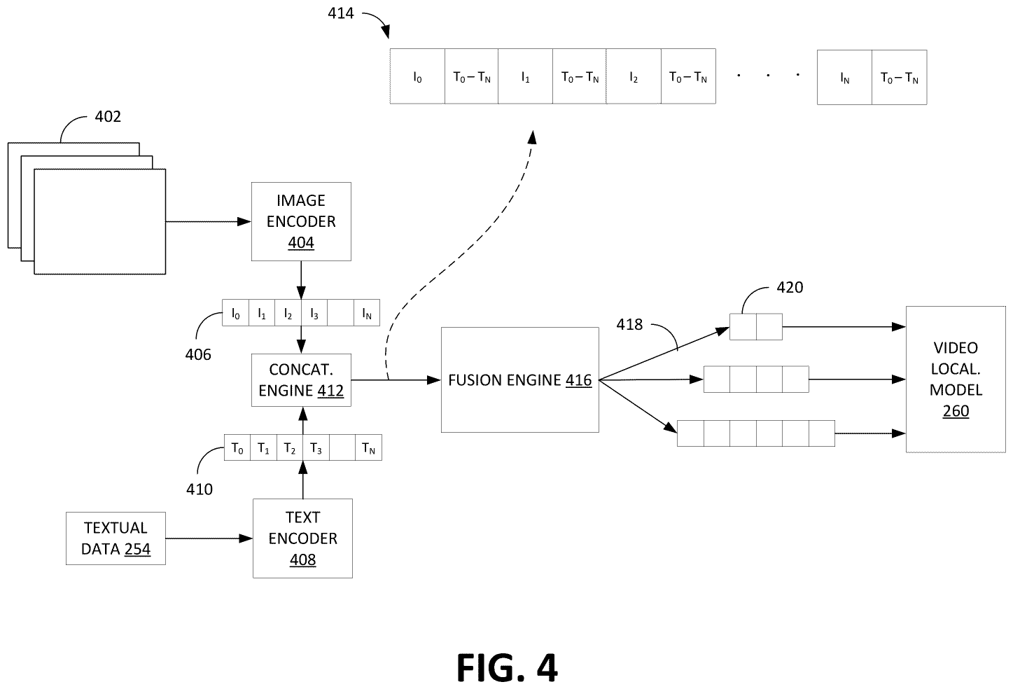

The system can generate fused video-textual data based on the obtained set of video embeddings and the obtained set of textual embeddings. In some embodiments, the system can generate the fused video-textual data by extracting a video embedding (e.g., a video token) representing the features of at least one video frame of the media item from the set of video embeddings. The system can perform one or more concatenation operations to concatenate (e.g., link together) the extracted video embedding with the set of textual embeddings and can update a dataset to include the extracted video embedding concatenated with the set of textual embeddings. In some embodiments, the system can concatenate the set of textual embeddings with each video embedding of the set of video embeddings, such that the dataset includes each video embedding concatenated with the set of textual embeddings. Further details and examples regarding the concatenation of the video embeddings with the textual embeddings are provided with respect to FIG. 4.

In some embodiments, the system can provide the dataset including the concatenated video and textual embeddings as input to a transformer encoder (e.g., an AI model or engine that processes an input sequence and produces a continuous representation or embedding of the input). The system can obtain one or more outputs of the transformer encoder, which can include a set of frame tokens that reflect a correspondence between a respective video embedding of the set of video embeddings and the concatenated set of textual embeddings. In some embodiments, the system can generate a feature pyramid based on the set of frame tokens obtained based on the output(s) of the transformer encoder. The feature pyramid can have multiple levels, where each level includes frame tokens at a different resolution than frame tokens at other levels of the feature pyramid. In an illustrative example, a first level (e.g., a top most level) can include the set of frame tokens at a first resolution and a second level (e.g., a lower level) can include the set of frame tokens at a second resolution that is lower than the first resolution. In an illustrative example in which the feature pyramid includes multiple levels, each successive level includes the set of frame tokens at a lower resolution than a preceding level (e.g., a lower level). Each level of the feature pyramid can provide information regarding features depicted by the media item at different levels of detail and/or pixel granularity, in some embodiments. In some embodiments, the system can generate the feature pyramid by performing one or more sampling operations (e.g., down sampling operations) to the set of frame tokens to obtain the set of frame tokens at the different resolutions. Further details regarding the feature pyramid are provided below. The fused video-textual data generated by the system can include the feature pyramid.

Upon generating the fused video-textual data, the system can provide the fused video-textual data as input to an AI model that is trained to perform multiple video localization tasks, including but not limited to moment retrieval tasks, temporal action localization tasks, action segmentation tasks, and/or highlight detection tasks. In some embodiments, the AI model (referred to herein as a video localization model) can include one or more model heads that each correspond to a respective video localization task. The AI model can be trained using fused video-text data obtained for training media items, in some embodiments. Details regarding training of the video localization model are provided herein. The system can obtain one or more outputs of the video localization model which can indicate a segment (e.g., a sequence of video frames) of the media item that depicts the event of interest and/or the event of the request for content. In some embodiments, the one or more outputs of the video localization model can indicate multiple segments of the media item and provide, for each segment, a level of confidence that content of the video segment is relevant to the event. The system can identify the segment of the one or more outputs having a level of confidence that satisfies one or more confidence criteria and can provide the identified segment of the media item for presentation to a user of a platform (e.g., via a client device associated with the user).

Aspects of the present disclosure provide techniques for a video localization AI model that is trained to perform multiple video localization tasks, where text embeddings pertaining to the content of a given media item is fused with video embeddings early in the AI pipeline, allowing improved video segment identification. As described above, fused video-text data is used for training and inference of the video localization model, which provides the video localization model with contextual information regarding the media item, while minimizing the amount of data that is provided to the model. This enables the video localization model to more accurately predict or identify segments of a media item associated with a particular action or event of interest, while minimizing the amount of computing resources (e.g., processing cycles, memory space, etc.) consumed during training and/or inference. Further, embodiments of the present disclosure enable video localization tasks to be performed for a media item with or without a providing the video localization model with a prompt indicating a particular action or event for identification, which enables the system to identify segments of media items that depict a wide range and variety of actions or events. In addition, embodiments of the present disclosure provide that the video localization model is trained to perform multiple video localization tasks, which reduces the overall amount of time and computing resources consumed for performing video localization and/or training the AI model to perform such tasks. As embodiments of the present disclosure enable fewer computing resources to be consumed, such resources are made available for other processes of the system, and an overall system latency is decreased and an overall system efficiency is increased. In addition, as described herein, the video localization can be used to identify video segments depicting an event that has been provided as an input of an enhanced video search engine, and the video segments identified as depicting the input event can be returned as outputs of the enhanced video search engine.

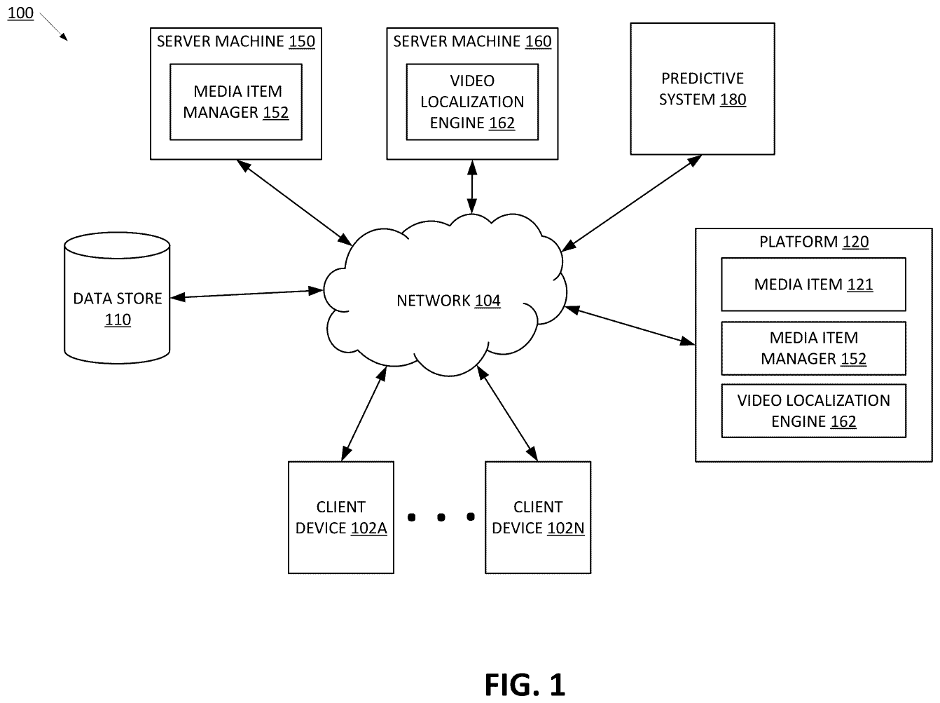

FIG. 1 illustrates an example system architecture 100, in accordance with implementations of the present disclosure. The system architecture 100 (also referred to as “system” herein) includes one or more client devices 102A-N, a data store 110, a platform 120 (e.g., a content sharing platform, a conference platform, etc.), one or more server machines (e.g., server machine 150, server machine 160, etc.), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data can include one or more media items, in some embodiments, where each media item includes audio data and/or video data, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., server machines 130-140) coupled to the platform 120 via network 104.

Client devices 102A-N(collectively and individually referred to as client device(s) 102 herein). can include one or more computing devices such as personal computers (PCs), laptops, mobile phones, smart phones, tablet computers, netbook computers, network-connected televisions, etc. In some implementations, a client device 102 can also be referred to as a “user device.” Client devices 102 can include a content viewer. In some implementations, a content viewer can be an application that provides a user interface (UI) for users to view or upload content, such as images, media items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). According to aspects of the disclosure, the content viewer can be a content sharing platform application for users to record, edit, and/or upload content for sharing on platform 120. As such, the content viewers can be provided to client devices 102A-N by platform 120. For example, the content viewers may be embedded media players that are embedded in web pages provided by the platform 120.

A media item 121 can be consumed via the Internet or via a mobile device application, such as a content viewer of client devices 102. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content sharing platform application), transmitting the media item 121 to the client device 102, and/or presenting or permitting presentation of the media item 121 via client device 102.

In some embodiments, platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

In some embodiments, media item 121 can be a media item. A media item refers to a set of sequential video frames (e.g., image frames) representing a scene in motion. For example, a series of sequential video frames can be captured continuously or later reconstructed to produce animation. Media items can be provided in various formats including, but not limited to, analog, digital, two-dimensional and three-dimensional video. Further, media items can include movies, video clips, video streams, or any set of images (e.g., animated images, non-animated images, etc.) to be displayed in sequence. In some embodiments, a media item can be stored (e.g., at data store 110) as a video file that includes a video component and an audio component. The video component can include video data that corresponds to one or more sequential video frames of the media item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include a media item manager 152 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 152 can store the media item 121 at data store 110 (e.g., at a media item corpus or repository of data store 110).

In some embodiments, media item manager 152 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 152 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title and/or a caption pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 152 can store the data or metadata with media item 121 at data store 110.

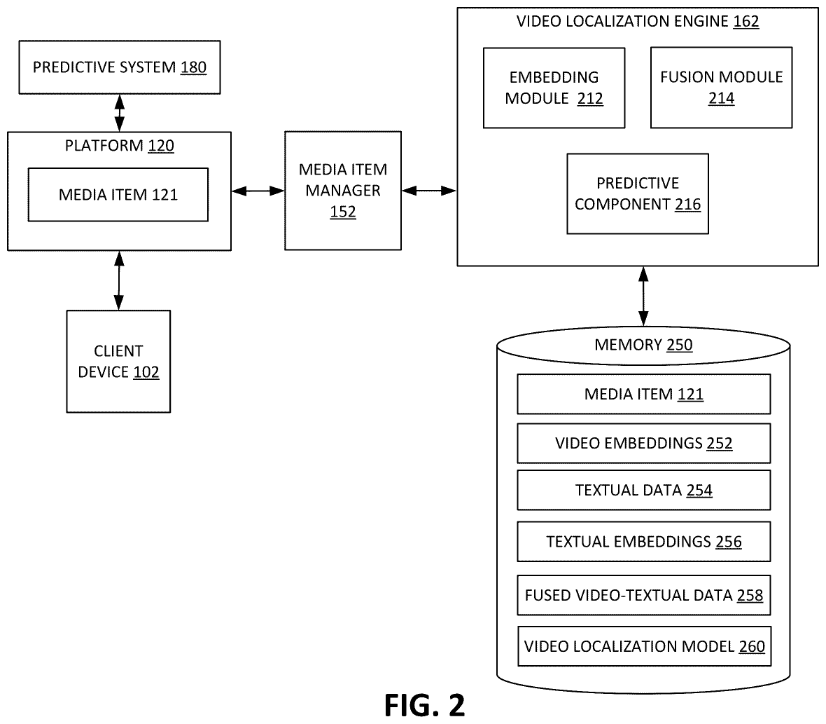

Video localization engine 162 can identify one or more segments of a media item 121 that include content depicting a particular event and/or content that is of interest to one or more users of platform 120. In some embodiments, a user (e.g., a creator) associated with a long-form media item may want to share content of the long-form media item as a short-form media item. For example, the creator of the long-form media item may want to identify a portion of content that is interesting or relevant to other users of platform 120 and include that identified portion of content in a short-form media item for access by the other users. In such embodiments, video localization engine 162 may identify one or more segments of the long-form media item that are interesting or relevant to the user, for inclusion in the short-form media item. In other or similar embodiments, a user may want to identify a segment of a long-form media item that depicts a particular event or action. Video localization engine 162 can identify a segment of the long-form media item for inclusion in the short-form media item. Details regarding video localization engine 162 are provided herein with respect to FIGS. 2-4.

As illustrated in FIG. 1, system 100 can also include a predictive system 180, in some embodiments. Predictive system 180 can implement one or more artificial intelligence (AI) and/or machine learning (ML) techniques for performing tasks associated with video localization. As described herein, video localization tasks can include moment retrieval tasks (e.g., identifying segments of a media item that correspond to an event or action of a natural language query), temporal action localization tasks (e.g., detecting a start time and/or an end time of a particular event or action and/or classifying the type of event or action taking place), action segmentation tasks (e.g., for each video frame or segment of a media item, identifying labels indicating an event or an action depicted by the video frame or segment), highlight detection tasks (e.g., identifying significant or interesting segments of a media item), and so forth. In some embodiments, predictive system 180 can train an AI model (e.g., a machine learning model) to perform multiple video localization tasks with respect to a media item 121 of platform 120. Video localization engine 162 can provide data pertaining to a media item 121 to predictive system 180 and/or one or more AI models of predictive system 180, and can obtain an indication of a segment depicting a particular event and/or an event of interest as an output of predictive system 180 and/or the one or more AI models. Further details regarding inference and training of the AI models are provided with respect to FIGS. 2-6 below.

It should be noted that although FIG. 1 illustrates media item manager 152 and video localization engine 162 as part of platform 120, in additional or alternative embodiments, one or more portions or components of media item manager 152 and/or video localization engine 162 can reside and/or be executed at client device(s) 102. In other or similar embodiments, one or more components of media item manager 152 and video localization engine 162 can reside on one or more server machines that are remote from platform 120. In an illustrative example, media item manager 152 can reside at server machine 150 and video localization engine 162 can reside at server machine 160, in additional or alternative embodiments. It should be noted that in some other implementations, the functions of platform 120, server machine 150, server machine 160, and/or predictive system 180 can be provided by more or a fewer number of machines. For example, in some implementations, components and/or modules of platform 120, server machine 150, server machine 160, and/or predictive system 180 may be integrated into a single machine, while in other implementations components and/or modules of any of platform 120, server machine 150, server machine 160, and/or predictive system 180 may be integrated into multiple machines. In addition, in some implementations, components and/or modules of server machine 150, server machine 160, and/or predictive system 180 may be integrated into platform 120.

In general, functions described in implementations as being performed platform 120, server machine 150, server machine 160, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of video localization engine 162 identifying a segment of video content depicting a particular event and/or an event of interest to a user, embodiments of the present disclosure can be performed with identifying a segment of audio content including a particular event and/or an event of interest to a user. Further, although some implementations and embodiments of the disclosure are discussed in terms of video localization tasks for media items 121 of platform 120 (e.g., a content sharing platform), implementations and embodiments of the present disclosure can be applied to any type of media item 121 or content streamed or otherwise provided to a client device 102.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120 and an example video localization engine 162, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 152 can identify media items 121 of interest and/or relevant to users (e.g., based on a user access history, a user search request, etc.) and can provide the users with access to the identified media items 121 via client devices 102. In some embodiments, a creator can provide platform 120 with a long-form media item for conversion to a short-form media item. The short-form media item may include a segment of content of the long-form media item that depicts a particular event and/or an event of interest to one or more other users of platform 120. As described above, video localization engine 162 can perform one or more tasks associated with identifying a segment of a media item 121 (e.g., a long-form media item) that depicts a particular event and/or an event of interest and providing users with access to the identified segment (e.g., as a short-form media item). As illustrated in FIG. 2, video localization 162 can include an embedding module 212, a fusion module 214, and/or a predictive component 216. Details regarding video localization engine 162 and the modules of video localization engine 162 are provided below with respect to FIGS. 2-4.

In some embodiments, platform 120, media item manager 152, video localization engine 162, and/or predictive system 180 can be connected to memory 250 (e.g., via network 104, via a bus, etc.). Memory 250 can correspond to one or more regions of data store 110, in some embodiments. In other or similar embodiments, one or more portions of memory 250 can include or otherwise correspond any memory of or connected to system 100.

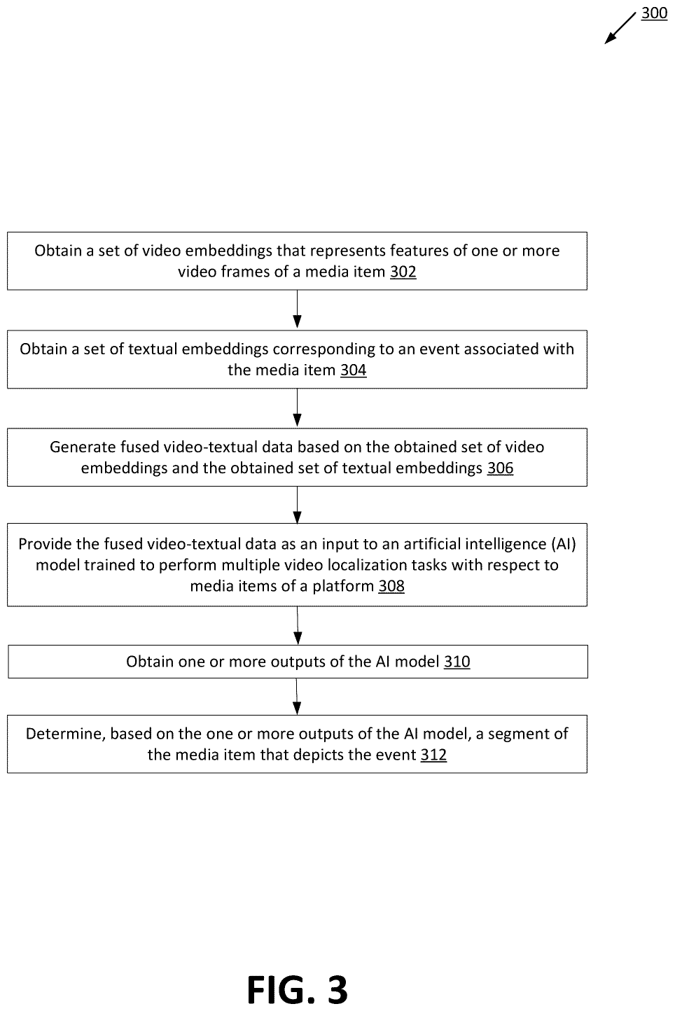

FIG. 3 depicts a flow diagram of an example method for video localization using artificial intelligence (AI), in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by video localization engine 162.

At block 302, processing logic obtains a set of video embeddings that represents features of one or more video frames of a media item. In some embodiments, embedding module 212 can obtain the set of embeddings for a media item 121 of platform 120, as described below. The media item 121 can be included in a media item corpus and/or a media item repository that includes media items 121 for access by users of platform 120, in some embodiments. In some embodiments, embedding module 212 can obtain the set of video embeddings for the media item 121 upon media item manager 152 receiving the media item 121 from a client device 102 associated with a creator of the media item. In other or similar embodiments, embedding module 212 can obtain the set of video embeddings for the media item 121 upon a request for content by a user (e.g., a viewer) of platform 120.

FIG. 4 depicts an example of video localization using AI, in accordance with embodiments of the present disclosure. As descried above, a media item 121 can include or be made up of a sequence of video frames 402 that each depict a still image of content associated with the media item 121. When played in sequence with other frames 402 of the media item 121, the frames 402 depict motion on a playback surface (e.g., a UI of client device 102).

In some embodiments, embedding module 212 can obtain the set of embeddings based on one or more outputs of an image encoder 404. An image encoder refers to an AI model (or a component of an AI model) that transforms raw image data into a structured, high-dimensional representation (e.g., a feature vector) of features or information of the image. An image encoder 404 can take an image, such as a video frame 402, as an input and can extract features from the input image by applying a series of filters to capture various aspects of the image, such as edges, textures, colors, patterns, and so forth. The filters applied to the input image and/or the aspects of the image captured by the image encoder 404 may be defined and/or specified based on the training of the image encoder 404. In some embodiments, image encoder 404 is employed using a deep learning approach, such as that of a convolutional neural network (CNN) architecture. In such embodiments, the image encoder 404 can include or be made up of a network including multiple layers, such as a convolutional layer (e.g., which applies various filters to the image to create feature maps highlighting different features at various scales), an activation function layer (e.g., which introduces non-linearities into the network, allowing it to learn more complex patterns), a pooling layer (e.g., which reduces the dimensionality of the feature maps, which enable the representation to be abstract and invariant to small changes in the input image), and/or a normalization layer (e.g., which stabilize the learning process and improve the convergence of training of the image encoder 404). In some embodiments, an output of the image encoder 404 can include a feature vector (or a set of feature vectors) that represent the content of the input image in a compressed and informative way. In some embodiments, the image encoder 404 can include a visual geometry group deep convolutional network (VGGNet) encoder, a residual network (ResNet) encoder, an inception encoder, an autoencoder, and so forth.

As indicated above, embedding module 212 can provide one or more image frames 402 of media item 121 as an input to image encoder 404 and can obtain the set of video embeddings 252 based on one or more outputs of the image encoder 404. Each of the set of video embeddings 252 can include or correspond to a frame token 406, which refers to a unit of processed information output by an image encoder 404. Each frame token 406 can represent the features of one or more frames 402 of the media item 121, in some embodiments. As illustrated by FIG. 2, in some embodiments, embedding module 212 can store the set of video embeddings 252 at memory 250, which can include or otherwise references frame tokens 406.

Referring back to FIG. 3, at block 304, processing logic obtains a set of textual embeddings corresponding to an event associated with the media item. In some embodiments, embedding module 212 can obtain the set of textual embeddings based on one or more outputs of a text encoder 408. A text encoder refers to an AI model (or a component of an AI model) that transforms raw text into a fixed, high-dimensional representation (e.g., a feature vector) of semantic properties of the input text. A text encoder 408 can take text as an input and can break down the input text into smaller components, such as words, subwords, or characters (e.g., tokens). Text encoder 408 can then map each token to a vector in a high-dimensional space, which are learned to capture semantic and syntactic meanings of the words (e.g., according to a training of the text encoder 408). Text encoder 408 can update or adjust the token embeddings based on the context in which they appear in the text and can combine the contextual embeddings of the individual tokens into a single or sequence of vectors that represent larger units of text (e.g., sentences, paragraphs, entire documents, etc.). In some embodiments, text encoder 408 can be or otherwise include a recurrent neural network (RNN), a convolutional neural network (CNN), a transformer, a pre-trained language model (e.g., a Bidirectional Encoder Representations from Transformers (BERT) model, a Generative Pre-trained Transformer (GPT) model, etc.), and so forth.

In some embodiments, embedding module 212 can provide textual data 254 associated with the video item 121 as an input to text encoder 408 and can obtain the set of textual embeddings 256 as an output of the text encoder 408. The textual data 254 can include information pertaining to the content of the media item 121, in some embodiments. For example, textual data 254 can include a title of the media item 121, a caption of the media item 121 (e.g., as provided by a creator of the media item 121), one or more tags or keywords associated with the media item 121 (e.g., as provided by the creator or another system or process associated with platform 120), and so forth. In other or similar embodiments, textual data 254 can include or otherwise reference a transcript of an audio of the media item 121, comments provided by one or more users (e.g., viewers) of the media item 121, search queries associated with media item 121, and so forth. In some embodiments, the textual data 254 can additionally or alternatively include information of a request provided by a user (e.g., a viewer) of platform 120 for content depicting a particular event. In an illustrative example, a user of platform 120 can provide a request (e.g., a search query, etc.) for content relating to baking cookies. The textual data 254 can include information indicating the requested content (e.g., baking cookies), in some embodiments.

Each of the set of textual embeddings 256 obtained based on output(s) of the text encoder 408 can include or correspond to a text token 410, which refers to a unit of processed information output by a text encoder 408. Each text token 406 can represent features of one or more segments of text (e.g., a word, a subword, a character, a sentence, a paragraph, etc.) of textual data 254. In some embodiments, the set of textual embeddings 256 can include a single text token 410 that represents the entirety of the textual data 254. In other or similar embodiments, the set of textual embeddings 256 can include multiple text tokens 410 that each represent a distinct segment of textual data 254.

In some embodiments, image encoder 404 and/or text encoder 408 can be components of an additional AI model that is trained to predict a correspondence between given text data and given image data. By providing the image encoder 404 and the text encoder 408 as components of the same pre-trained additional AI model, a strong prior on measuring relevancy can be obtained. The additional AI model can be part of a dual-encoder system and can be trained on a vast corpus of text-image pairs, allowing it to develop a nuanced understanding of complex visual and textual content. The additional AI model may be trained (e.g., by predictive system 180, by another system) according to contrastive learning techniques, which align image and text embeddings in a shared multidimensional space. In some embodiments, the additional AI model can be or include a contrastive language-image pre-training (CLIP) model.

Referring back to FIG. 3, at block 306, processing logic generates fused video-textual data based on the obtained set of video embeddings and the obtained set of textual embeddings. Fused video-textual data 258 refers to data that is generated or otherwise obtained by fusion module 214 of video localization engine 162 and represents features of both video frames 402 and textual data 254 associated with media item 121. As indicated above, fusion component 214 of video localization engine 162 can generate fused video-textual data 258 based on the set of video embeddings 252 and the set of textual embeddings 256, as described below.

In some embodiments, fusion component 214 can include or otherwise have access to a concatenation engine 412 that performs one or more concatenation operations to concatenate (e.g., link together) given input data. In some embodiments, fusion component 214 can extract a frame token 406 from the set of video embeddings 252 and can provide the extracted frame token 406 to the concatenation engine 412. Fusion component 214 can additionally provide the set of textual embeddings 256 (e.g., which includes a single text token 410 for textual data 254 or multiple text tokens 410 for textual data 254) to concatenation engine 412. Concatenation engine 412 can perform one or more concatenation operations to concatenate the extracted frame token 406 with the set of textual embeddings 256. Fusion component 214 can update a dataset 414 to include the extracted video token 406 concatenated with the set of textual embeddings 256. In some embodiments, fusion component 214 can provide each respective frame token 406 of the set of video embeddings 252 to concatenation engine 412 for concatenation with the set of frame tokens and can update dataset 414 to include each frame token 406 concatenated with the set of textual embeddings 256. As illustrated in FIG. 4, the updated dataset 414 can include each image token 406 of the set of video embeddings 252 concatenated with the set of textual embeddings 256. For example, the updated dataset 414 includes the image token I₀, which is concatenated with text tokens T₀-T_{N}, the image token I₁, which is concatenated with text tokens T₀-T_{N}, and so forth.

In some embodiments, fusion module 214 can provide the updated dataset 414 as an input to a fusion engine 416 that generates a set of frame tokens representing a correspondence between a respective video embedding (e.g., video token 406) extracted from the set of video embeddings 252 and the concatenated set of textual embeddings 256. In some embodiments, fusion engine 416 can include or otherwise implement a transformer encoder. A transformer encoder is an AI model (or is a component of an AI model) that transforms input data into a continuous representation (e.g., feature vector) that retains semantic meaning and relational information between different parts of the input. In some embodiments, a transformer encoder can include a stack of identical layers that each contain a multi-head self-attention mechanism and a position-wise feed-forward network. The multi-head self-attention mechanism of each layer allows the model to weigh the importance of different input elements (e.g., video tokens 406, text tokens 410, etc.), irrespective of their positions in the input sequence. Such mechanism also splits the self-attention process into multiple “heads,” allowing the model to jointly attend to information from different representation subspaces at different positions.

Fusion module 214 can provide the updated dataset 414, including the concatenated frame tokens 406 and text token(s) 410, as an input to the fusion engine 416 and can obtain a set of frame tokens 418 as an output of the fusion engine 416 (e.g., in accordance with the output of the transformer encoder). As described above, the set of frame tokens 418 can be or otherwise include a feature vector that reflects the correspondence between each of the frame embeddings 406 and the text tokens 410.

In some embodiments, fusion module 214 can generate a feature pyramid 420 based on the set of frame tokens 418. A feature pyramid 420 refers to a collection of data that is generated based on image frame embeddings and is a multi-scale representation of content associated with the image frames of the image frame embeddings. A feature pyramid 420 has a hierarchical structure where each level of the pyramid represents features at a different scale, with higher levels having coarser (e.g., lower resolution but semantically stronger) features and lower levels having finer (e.g., higher resolution but semantically weaker) features. In some embodiments, the highest level of the feature pyramid 420 includes embeddings associated with an entire image (e.g., of an image frame 402) and/or large portions of the image, which provides the high-level semantic information pertaining to content of the image (e.g., the presence of an object). As indicated above, embeddings of the highest level have the lowest resolution but cover the largest field of view of the content. Intermediate levels of the feature pyramid 420 progressively increase in resolution and decrease in field of view. The lowest level of the feature pyramid 420 includes embeddings with the highest resolution, and depict small regions of the image to capture fine details of the overall image. In some embodiments, the feature pyramid 420 can include or correspond to a Feature Pyramid Network (FPN), which includes connections between features from different scales.

Fusion module 214 can generate the feature pyramid by performing one or more sampling operations with respect to the frame tokens 218 output by the fusion engine 416. The one or more sampling operations can include down sampling operations, which reduce the resolution of input frame tokens 218 and/or upsampling operations, which increase the resolution of input frame tokens 218. In some embodiments, a down sampling operation can include or involve pooling or strided convolutions in a convolutional neural network to reduce dimensionality of the features associated with an input frame token 218. In additional or alternative embodiments, an upsampling operation can involve bilinear interpolation, transposed convolutions, and/or learnable upsampling to recover spatial resolution of the input frame token 218.

In an illustrative example, the highest level of the feature pyramid 420 can include the frame tokens 418 output by the fusion engine 416. Fusion module 214 can perform one or more down sampling operations with respect to the frame tokens 418 to generate one or more intermediate layers of the feature pyramid 420. To generate each lower level of the feature pyramid 420, fusion module 214 may perform a down sampling operation with respect to the frame token 418 of the level directly above the lower level. Each token 418 of the feature pyramid 420 (including the tokens 418 of the highest level) are referred to herein as sampled tokens.

Fusion module 214 can store the generated feature pyramid 420 at memory 250 as the fused video-textual data 258, which is fed as input to a video localization AI model 260, as described below. It should be noted that although some embodiments refer to the generated feature pyramid 420 being fed as input to video localization AI model 260, other data described with respect to FIG. 4 can be fed as input to video localization AI model 260. For example, the dataset 414 including the concatenated frame tokens 406 and text tokens 410 can be fed as an input to video localization AI model 260, in some embodiments. In another example, the frame tokens 218 output by fusion engine 416 can be fed as an input to video localization AI model 260, in other or similar embodiments.

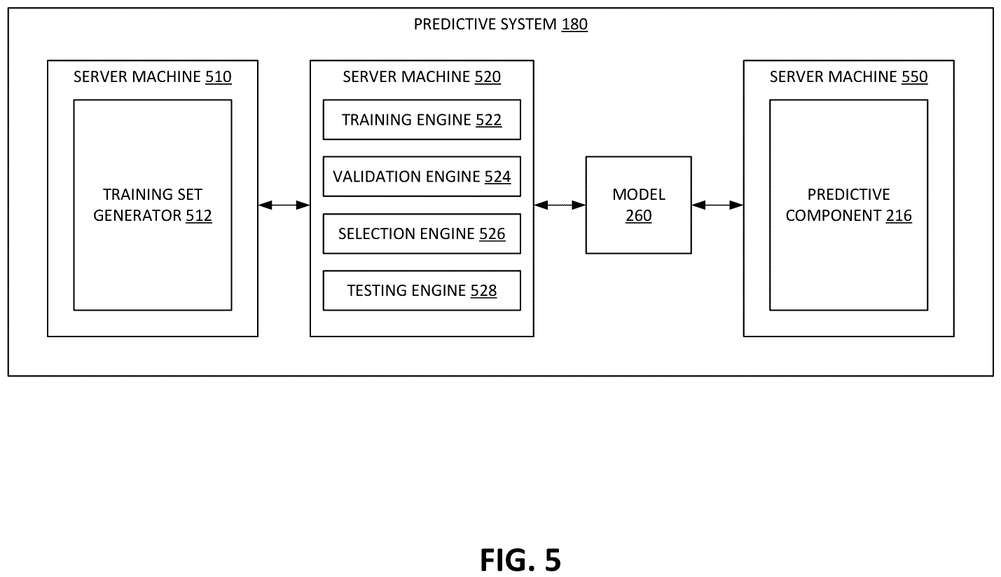

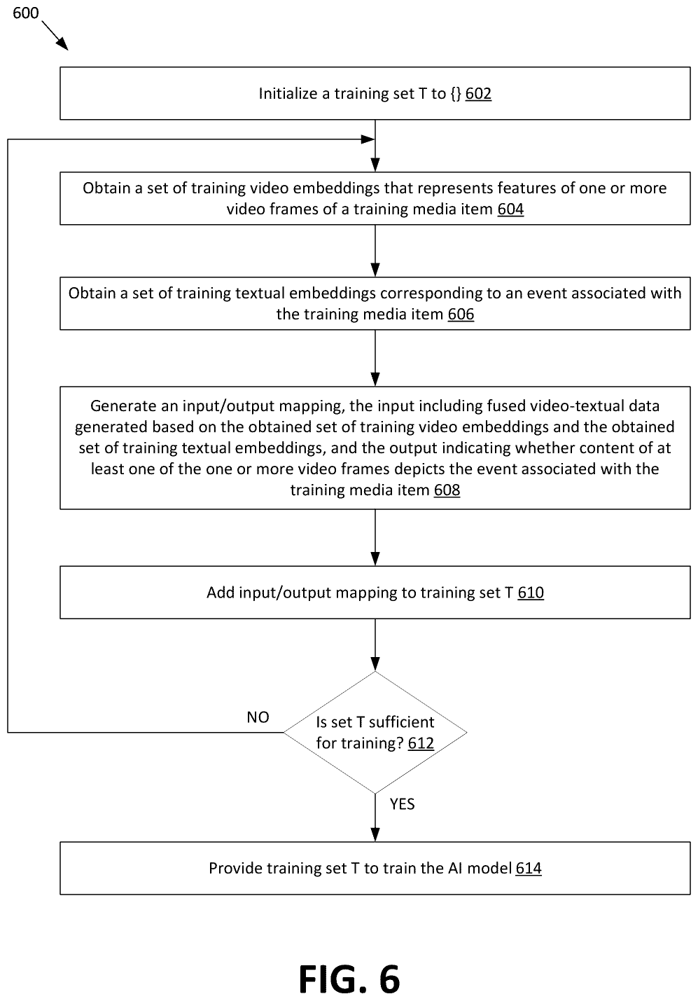

Referring back to FIG. 3, at block 308, processing logic provides the fused video-textual data as an input to an AI model trained to perform multiple video localization tasks with respect to media items of a platform. The AI model can include video localization AI model 260. As described above, video localization AI model 260 (also referred to as video localization model 260) can be trained to perform video localization tasks including moment retrieval tasks (e.g., identifying segments of a media item 121 that correspond to an event or action of a natural language query), temporal action localization tasks (e.g., detecting a start time and/or an end time of a particular event or action and/or classifying the type of event or action taking place), action segmentation tasks (e.g., for each video frame or segment of a media item 121, identifying labels indicating an event or an action depicted by the video frame or segment), highlight detection tasks (e.g., identifying significant or interesting segments of a media item 121), and so forth. Further details regarding training the video localization model 260 are provided with respect to FIGS. 5 and 6 below. The video localization model 260 can include or be composed of a convolutional neural network (CNN), a recurrent neural network (RNN), a long short-term memory network (LSTMs), a three dimensional (3D) CNN, a two-stream network, a transformer model, a region based CNN (R-CNN), a temporal segment network (TSN), a graph convolutional network (GCN), and so forth.

In some embodiments, video localization model 260 can include multiple model heads that each correspond to a respective video localization task, as described above. Each model head can, in some embodiments, output a predicted relevancy score and/or predicted displacement regression metrics associated with the respective video localization tasks for the model head. The predicted relevancy score indicates the likelihood or a level of confidence that a set of image frames corresponding to a given embedding satisfies one or more criteria. The predicted displacement regression metrics indicate adjustments to be applied to coordinates for bounding boxes that indicate objects detected by the video localization model 260. With respect to the moment retrieval tasks, output by the corresponding model head indicates a level of confidence that a set of image frames depicts an event (e.g., an event of interest, an event indicated by a request, etc.). With respect to the temporal action localization tasks, the output by the corresponding model head indicates a level of confidence that a respective video frame 402 and/or set of video frames 402 is within a start time and/or an end time of the event and/or a level of confidence that the actions depicted by the video frame 402 or set of video frames 402 is associated with a particular class of actions. With respect to the action segmentation task, the output by the corresponding model head indicates a level of confidence that an event or an action depicted by the video frame 402 or set of video frames 402 is associated with a particular label or tag. With respect to the highlight detection tasks, the output by the corresponding model head can indicate a level of confidence that the video frame 402 or the set of video frames 402 depicts a content segment of interest.

As described above, predictive component 216 of video localization engine 162 can provide the fused video-textual data 258 as an input to the video localization model 260. The input fused video-textual data 258 can include the feature pyramid 420, as described above, and/or the data set 414 including the concatenated frame tokens 406 and text tokens 410, or the frame tokens 218 output by fusion engine 416.

Referring back to FIG. 3, at block 310, processing logic obtains one or more outputs of the AI model. The output(s) of the video localization model 260 may differ depending on the localization task performed by the model. For example, with respect to the moment retrieval tasks, the output of the model 260 can indicate a level of confidence that a set of image frames 402 depicts an event (e.g., an event of interest, an event indicated by a request, etc.). In another example, with respect to the temporal action localization tasks, the output of the model 260 can indicate a level of confidence that a respective video frame 402 and/or set of video frames 402 associated with within a start time and/or an end time of the event and/or a level of confidence that the actions depicted by the video frame 402 or set of video frames 402 is associated with a particular class of actions. In another example, with respect to the action segmentation task, the output of the model 260 can indicate a level of confidence that an event or an action depicted by the video frame 402 or set of video frames 402 is associated with a particular label or tag. In another example, with respect to the highlight detection tasks, the output of the model 260 can indicate a level of confidence that the video frame 402 or the set of video frames 402 depicts a content segment of interest.

At block 312, processing logic determines, based on the one or more outputs of the AI model, a segment of the media item that depicts the event. Predictive component 216 can determine a segment of the video item depicting the event by identifying the segment having level(s) of confidence that satisfy one or more confidence criteria, as indicated by the output(s) of the model. For example, predictive component 216 can determine a segment of the video item depicts an event of the request by determining that the level of confidence (e.g., output by the moment retrieval model head, the temporal action localization head, and/or the action segmentation head) for the segment meets or exceeds a threshold level of confidence and/or is larger than the levels of confidence for other segments. In another example, predictive component 216 can determine a segment of the video item depicts an event (e.g., of a request, of interest) by determining that the level of confidence (e.g., output by the temporal action localization head, the action segmentation head, and/or the highlight detection head) for the segment meets or exceeds a threshold level of confidence and/or is larger than the levels of confidence for other segments.

Upon determining a segment of the media item that depicts the event (e.g., of the request, of interest, etc.), media item manger 152 can provide the segment of the media item 121 to one or more users of platform 120 as a short-form media item. In some embodiments, media item manager 152 can provide the segment to the creator of the media item 121 via a UI of a client device 102 associated with the creator. The creator can provide an indication (e.g., by engaging with one or more UI elements of the UI) of whether the segment is to be provided for access to other users (e.g., viewers) of platform 120 as a short-form media item 121. In other or similar embodiments, platform 120 may perform the video localization tasks with respect to a media item 121 upon receiving a request from a user of platform 120 for access to content depicting a particular event. Media item manager 152 can provide the determined segment for presentation to the user via a client device 102 associated with the user, in accordance with the request.

It should be noted that although embodiments of the present disclosure are described with respect to video localization tasks, such embodiments can be applied to performing audio localization tasks. An audio localization refers to the identification of segments of a media item that includes audio pertaining to a particular event and/or is associated with particular attributes (e.g., includes a chorus of a song, etc.). Audio localization tasks can include the same or similar tasks relating to video localization, such as moment retrieval tasks, temporal action localization tasks, action segmentation tasks, highlight detection tasks, and so forth. In some embodiments, embodiments and examples described with respect to FIGS. 2-4 for video localization of video data can also or similarly be applied to audio data for audio localization. For example, video localization engine 162 can provide audio data of a media item 121 as an input to an audio encoder (e.g., an AI model or engine that converts an audio signal into a vector representation that captures the audio features of the input audio data) and obtain a set of audio embeddings as an output of the signal. In some embodiments, the media item 121 can include audio data and video data and, in some instances, each of the obtained set of audio embeddings may correspond to audio associated with a particular frame (or set of frames) of the video data. Video localization engine 162 can obtain a set of textual embeddings associated with media item 121, as described herein. Video localization engine 162 can provide the set of audio embeddings and the set of textual embeddings as an input to concatenation engine 412 and can obtain the updated data set 414 (e.g., which includes audio tokens extracted from the set of audio embeddings concatenated with the set of textual embeddings), as described above. Video localization engine 162 can provide the updated data set 414 as an input to fusion engine 416, and can obtain a set of audio tokens from one or more outputs of fusion engine 416. The set of audio tokens can be or otherwise include a feature vector that reflects the correspondence between each of the set of audio embeddings and the text tokens 410, in some embodiments. In some embodiments, video localization engine 162 can generate a feature pyramid 420 based on the obtained set of audio tokens, as described above, and, in some instances, can feed the generated feature pyramid to video localization AI model 260. Video localization AI model 260 can, in some embodiments, perform audio localization tasks pertaining to given audio data, as described above. An output of video localization AI model 260 can include an indication of a segment of the audio data of media item 121 that includes audio corresponding to an event (e.g., a particular event, an event of interest, etc.).

In some embodiments, video localization engine 162 can generate a respective feature pyramid 420 for audio data of a media item 121 and a respective feature pyramid 420 for video data of media item 121, as described above. The generated feature pyramids 420 can be provided as input to video localization model 260, in some embodiments. In some embodiments, Video localization model 260 can perform video localization tasks and audio localization tasks for a media item 121 based on the given feature pyramids 420 and/or other data provided as an input to model 260.

FIG. 5 illustrates an example predictive system 180, in accordance with implementations of the present disclosure. As illustrated in FIG. 5, predictive system 180 can include a training set generator 512 (e.g., residing at server machine 510), a training engine 512, a validation engine 524, a selection 526, and/or a testing engine 528 (e.g., each residing at server machine 520), and/or a predictive component 552 (e.g., residing at server machine 550). Training set generator 512 may be capable of generating training data (e.g., a set of training inputs and a set of target outputs) to train AI model 260. Model 260 can include a video localization AI model that is trained to perform multiple video localization tasks, as described above.

As mentioned above, training set generator 512 can generate training data for training a model 260. Details regarding generating training data for training a model 260 are provided with respect to FIG. 6 below. FIG. 6 depicts a flow diagram of an example method 600 for training an AI model to perform one or more video localization tasks, in accordance with implementations of the present disclosure. Method 600 can be performed by processing logic that can include hardware (circuitry, dedicated logic, etc.), software (e.g., instructions run on a processing device), or a combination thereof. In one implementation, some or all the operations of method 600 can be performed by one or more components of system 100 of FIG. 1. In some embodiments, some or all of the operations of method 600 can be performed by predictive system 180. For example, one or more operations of method 600 can be performed by training set generator 512.

At block 602, processing logic initializes a training set to zero (e.g., { }). At block 604, processing logic obtains a set of training video embeddings that represents features of one or more video frames of a training media item. In some embodiments, training set generator 512 (or another component of predictive system 180 and/or platform 120) can identify a set of media items 121 that are designated for training. The set of media items 121 can be specified by a developer or operator of platform 120, in some embodiments. In other or similar embodiments, a media item 121 can be designated for training responsive to a determination that a creator of the media item 121 has provided permission for the media item 121 to be used for training by platform 120. Training set generator 512 can identify the training media item from the set of media items 121 designated for training, in some embodiments. Training set generator 512 can obtain the set of embeddings in accordance with embodiments described with respect to FIGS. 3 and 4 (e.g., based on one or more outputs of image encoder 404).

At block 606, processing logic obtains a set of training textual embeddings corresponding to an event associated with the training media item. As described above, textual embeddings can be obtained by providing textual data associated with a media item 121 as input to a text encoder 408. In some embodiments, training set generator 512 can provide textual data associated with the training media item as an input to the text encoder 408 and obtain one or more outputs of the text encoder 408, which include the set of training textual embeddings. The textual data provided as input to the text encoder 408 can include the same or similar type of textual data described with respect to FIGS. 2-4 (e.g., a title of the training media item, a caption of the training media item, etc.). In some embodiments, the textual data can include a information of a historical request and/or an experimental request for content depicting a particular event, as described above.

At block 608, processing logic generates an input/output mapping, the input including fused video-textual data generated based on the obtained set of training video embeddings and the obtained set of training textual embeddings, and the output indicating whether content of at least one of more of the one or more video frames depicts the event associated with the training media item. Training set generator 512 can generate the fused video-textual data based on the training video embeddings and the training textual embeddings in accordance with previously described embodiments. In some embodiments, the indication of whether the content of the video frame(s) depicts the event (e.g., an event of interest, a particular event, etc.) can be provided as ground truth data by a developer or operator of platform 120. For example, a developer or operator of platform 120 can provide an indication of an event depicted by the video frame(s), one or more labels associated with objects depicted by the video frame(s), an indication of time stamps indicating a beginning and an ending of a segment that depicts the event, a classification of the event and/or actions depicted by the event, and/or an indication of whether the event depicted by the video frame(s) depicts an event of interest. The output of the input/output mapping can include, in some embodiments, indication(s) provided by the developer or the operator as ground truth data.

At block 610, processing logic adds the input/output mapping to training set T. At block 612, processing logic determines whether training set T is sufficient for training. Upon a determination that training set T is sufficient for training, method 600 continues to block 614. At block 612, processing logic provides training set T to train AI model 260. In some embodiments, training set generator 512 provides training set T to training engine 522. Upon a determination that training set T is not sufficient for training, method 600 returns to block 604, where additional training data is obtained, as described above.

As described above, in some embodiments, AI model 260 can be trained to perform audio localization tasks. Training set generator 512 may generate training data for training AI model 260, according to techniques described above with respect to FIG. 6. For example, training set generator 512 can obtain a set of audio embeddings for a media item 121 designated for training, as described above. In some embodiments, training set generator 512 can obtain the set of training audio embeddings based on one or more outputs of an audio encoder. Training set generator 512 can obtain a set of training textual embeddings associated with the training media item, as described above, and can generate an input/output mapping, the input mapping including fused audio-textual data generated based on the obtained set of training audio embeddings and the obtained set of training textual embeddings, and the output indicating whether content of at least one segment of an audio signal of the training media item is associated with an event (e.g., an event of interest, a particular event, etc.) associated with the training media item. Training set generator 512 can generate the fused audio-textual data according to embodiments described herein. In some embodiments, the fused audio-textual data can include or otherwise correspond to a feature pyramid for a set of audio tokens obtained based on one or more outputs of fusion engine 416, as described above. The indication of whether content of at least one segment of the audio signal is associated with the event associated with the training media item can be provided as ground truth data, as described above. Training set generator 512 can add the input/output mapping to training set T, as described above. In some embodiments, training set T can include input/output mappings generated based on video frames of a training media item and audio signals of the training media item.

Training engine 522 can train an AI model 260 using the training data (e.g., training set T) from training set generator 512. The machine learning model 260 can refer to the model artifact that is created by the training engine 222 using the training data that includes training inputs and/or corresponding target outputs (correct answers for respective training inputs). The training engine 522 can find patterns in the training data that map the training input to the target output (the answer to be predicted), and provide the machine learning model 260 that captures these patterns. The machine learning model 260 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 512 hosted by server machine 510.

Validation engine 524 may be capable of validating a trained machine learning model 260 using a corresponding set of features of a validation set from training set generator 512. The validation engine 524 may determine an accuracy of each of the trained machine learning models 560 based on the corresponding sets of features of the validation set. The validation engine 524 may discard a trained machine learning model 260 that has an accuracy that does not meet a threshold accuracy. In some embodiments, the selection engine 526 may be capable of selecting a trained machine learning model 260 that has an accuracy that meets a threshold accuracy. In some embodiments, the selection engine 526 may be capable of selecting the trained machine learning model 260 that has the highest accuracy of the trained machine learning models 260.

The testing engine 586 may be capable of testing a trained machine learning model 260 using a corresponding set of features of a testing set from training set generator 512. For example, a first trained machine learning model 260 that was trained using a first set of features of the training set may be tested using the first set of features of the testing set. The testing engine 528 may determine a trained machine learning model 260 that has the highest accuracy of all of the trained machine learning models based on the testing sets.

As described above, predictive component 216 of server 550 may be configured to feed data as input to model 660 and obtain one or more outputs. In accordance with previously described embodiments, predictive component 216 can fused video-text data 258 as input to model 260. In some embodiments, predictive component 216 can determine a segment depicting an event of interest based on one or more outputs of model 660, as described above.

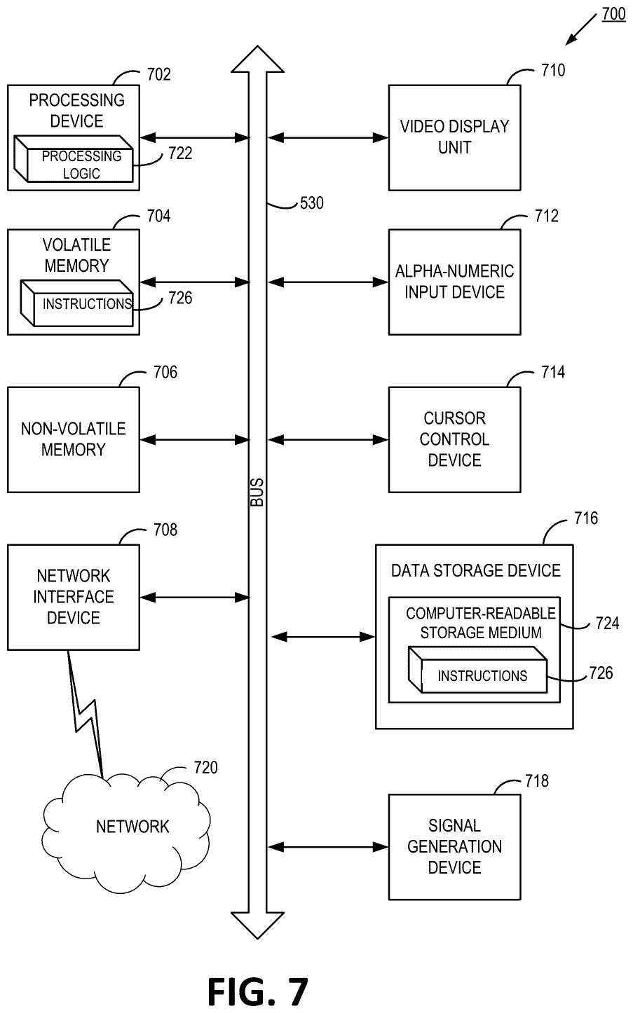

FIG. 7 is a block diagram illustrating an exemplary computer system 700, in accordance with implementations of the present disclosure. The computer system 700 can correspond to platform 120, client devices 102A-N, server machine 150, server machine 160, and/or predictive system 180 described herein and with respect to FIGS. 1-6. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
obtaining a set of video embeddings that represents features of one or more video frames of a media item;
obtaining a set of textual embeddings corresponding to an event associated with the media item;
generating fused video-textual data based on the obtained set of video embeddings and the obtained set of textual embeddings, wherein the fused video-textual data indicates features of the one or more video frames of the media item and textual data pertaining to the media item;
providing the fused video-textual data as an input to an artificial intelligence (AI) model trained to perform a plurality of video localization tasks with respect to media items of a platform;
obtaining one or more outputs of the AI model; and
determine, based on the one or more outputs of the AI model, a segment of the media item that depicts the event.

2. The method of claim 1, further comprising:
providing the one or more video frames as an input to an image encoder, wherein the set of video embeddings is obtained based on one or more outputs of the image encoder; and
providing textual data corresponding to the event associated with the media item as an input to a text encoder, wherein the set of textual embeddings is obtained based on one or more outputs of the text encoder.

3. The method of claim 2, wherein the image encoder and the text encoder are components of an additional AI model that is trained to predict a correspondence between given text data and given image data.

4. The method of claim 1, wherein generating the fused video-textual data comprises:
extracting, from the obtained set of video embeddings, a video embedding representing features of at least one of the one or more video frames;
performing one or more concatenation operations to concatenate the extracted video embedding with the set of textual embeddings; and
updating a dataset to include the extracted video embedding concatenated with the set of textual embeddings.

5. The method of claim 4, further comprising:
providing the updated dataset as an input to a transformer encoder; and
obtaining, based on one or more outputs of the transformer encoder, a set of frame tokens reflecting a correspondence between a respective video embedding extracted from the set of video embeddings and the concatenated set of textual embeddings.

6. The method of claim 5, further comprising:
performing one or more sampling operations with respect to the set of frame tokens to obtain, for each of the set of frame tokens, a plurality of sampled frame tokens, wherein each of the plurality of sampled frame tokens has a distinct resolution from other sampled frame tokens of the plurality of frame tokens,
wherein the generated fused video-textual data comprises the plurality of sampled frame tokens obtained for each of the set of frame tokens.

7. The method of claim 6, wherein the plurality of sampled frame tokens obtained for a respective frame token of the set of frame tokens corresponds to a feature pyramid comprising a plurality of levels, wherein the plurality of sampled frame tokens of a first level of the plurality of levels has a first resolution and the plurality of sampled frame tokens of a second level of the plurality of levels has a second resolution that is lower than the first resolution.

8. The method of claim 1, wherein the plurality of video localization tasks comprise at least one of:
predicting a correspondence between a segment of the one or more media items and one or more events indicated by one or more textual embeddings of the given data,
predicting a set of time stamps indicating the segment of the one or more media items that depicts one or more events indicated by the one or more textual embeddings of the given data,
predicting an action pertaining to one or more objects depicted by a video frame of the one or more media items, or
predicting a region of the video frame of the one or more media items depicting one or more actions that are of interest to one or more users of a platform.

9. The method of claim 1, further comprising:
receiving, from a client device connected to a platform, a request for content pertaining to the event; and
responsive to extracting the indication of the segment of the media item that depicts the event, providing the indicated segment of the media item for presentation via the client device in accordance with the received request.

10. The method of claim 1, wherein the output of the AI model comprises an indication of one or more segments of the media item and, for each of the one or more segments of the media item, a level of confidence that video frames of the respective segment of the media item depicts content corresponding to the event.

11. The method of claim 10, wherein the output of the AI model further comprises, for each of the one or more segments of the media item, an additional level of confidence that a duration of the one or more segments satisfies one or more duration criteria associated with a platform.

12. A system comprising:
a memory; and
a set of one or more processing devices coupled to the memory, wherein the set of one or more processing devices is to perform operations comprising:
generating a set of training data for training an artificial intelligence (AI) model to perform a plurality of video localization tasks, wherein generating the training data comprises:
obtaining a set of training video embeddings that represents features of one or more video frames of a training media item;
obtaining a set of training textual embeddings corresponding to an event associated with the training media item;
generating a training input comprising fused video-textual data generated based on the obtained set of training video embeddings and the obtained set of training textual embeddings, wherein the fused video-textual data indicates features of the one or more video frames of the training media item and textual data pertaining to the training media item; and
generating a target output for the training input, wherein the target output indicates whether content of at least one of the one or more video frames of the training media item depicts the event associated with the media item; and
providing the training data to train the AI model on (i) a set of training inputs comprising the training input and (ii) a set of target outputs comprising the target output.

13. The system of claim 12, wherein the operations further comprise:
providing the one or more video frames of the training media item as an input to an image encoder, wherein the set of training video embeddings is obtained based on one or more outputs of the image encoder; and
providing textual data corresponding to the event associated with the training media item as an input to a text encoder, wherein the set of training textual embeddings is obtained based on one or more outputs of the text encoder.

14. The system of claim 13, wherein the image encoder and the text encoder are components of an additional AI model that is trained to predict a correspondence between given text data and given image data.

15. The system of claim 12, wherein generating the training input comprising the fused video-textual data comprises:
extracting, from the obtained set of training video embeddings, a video embedding representing features of at least one of the one or more video frames;
performing one or more concatenation operations to concatenate the extracted video embedding with the set of training textual embeddings; and
updating a dataset to include the extracted video embedding concatenated with the set of textual embeddings.

16. The system of claim 15, wherein the operations further comprise:
providing the updated dataset as an input to a transformer encoder; and
obtaining, based on one or more outputs of the transformer encoder, a set of frame tokens indicating a correspondence between a respective video embedding extracted from the set of training video embeddings and the concatenated set of textual embeddings.

17. The system of claim 16, wherein the operations further comprise:
performing one or more sampling operations with respect to the set of frame tokens to obtain, for each of the set of frame tokens, a plurality of sampled frame tokens, wherein each of the plurality of sampled frame tokens has a distinct resolution from other sampled frame tokens of the plurality of frame tokens,
wherein the generated fused video-textual data comprises the plurality of sampled frame tokens obtained for each of the set of frame tokens.

18. The system of claim 17, wherein the plurality of sampled frame tokens obtained for a respective frame token of the set of frame tokens corresponds to a feature pyramid comprising a plurality of levels, wherein the plurality of sampled frame tokens of a first level of the plurality of levels has a first resolution and the plurality of sampled frame tokens of a second level of the plurality of levels has a second resolution that is lower than the first resolution.

19. The system of claim 12, wherein the generated target output comprises a relevancy score indicating a degree of relevancy of the content of the at least one of the one or more video frames to the event associated with the media item.

20. A non-transitory computer readable storage medium comprising instructions that, when executed by a processing device, cause the processing device to:
obtaining a set of video embeddings that represents features of one or more video frames of a media item;
obtaining a set of textual embeddings corresponding to an event associated with the media item;
generating fused video-textual data based on the obtained set of video embeddings and the obtained set of textual embeddings, wherein the fused video-textual data indicates features of the one or more video frames of the media item and textual data pertaining to the media item;
providing the fused video-textual data as an input to an artificial intelligence (AI) model trained to perform a plurality of video localization tasks with respect to media items of a platform;
obtaining one or more outputs of the AI model; and
determine, based on the one or more outputs of the AI model, a segment of the media item that depicts the event.
